(19) United States
(12) Patent Application Publication
(10) Pub. No.: US 2023/0257942 A1
(43) Pub. Date: Aug. 17, 2023

(54) FILAMENT FOR OBTAINING ARTIFICIAL TURF SURFACES

(71) Applicant: ITALGREEN S.P.A., Villa d'Adda (Bergamo) (IT)

(72) Inventor: Maurizio GILARDI, Villa d'Adda (Bergamo) (IT)

(21) Appl. No.: 18/006,770

(22) PCT Filed: Jul. 29, 2021
(86) PCT No.: PCT/IB2021/056912

§ 371 Date: Jan. 25, 2023

(30) Foreign Application Priority Data
Jul. 30, 2020 (IT) 102020000018643

(51) Int. Cl. E01C 13/08

(52) U.S. Cl. CPC E01C 13/08; B29C 48/0018

(57) ABSTRACT

A polyethylene filament for artificial turf that includes an antibacterial and antiviral additive is provided. The artificial turf is for sports fields. A method for making the polyethylene filament is also provided.

The present invention relates to a filament for obtaining an artificial turf surface, for example, for playgrounds and sports fields.

As is well known, artificial turf surfaces comprise a substrate from which filaments made of polymeric material, such as polyethylene, protrude. An infill material is then placed between the filaments, the composition of which depends on the intended use of the surface and the technical features and performance required thereof.

The invention is in particular placed in the current context of the emergency caused by the coronavirus (Sars Cov-2), wherein great attention is paid to all those preventive measures that can counteract the spread of the virus.

Even facilities for sports and recreational activities are subject to special safety measures suitable to allow activities to be conducted by limiting the risk of infection among persons using the facilities.

In the case of sports fields, a preventive measure involves periodically irrigating the field with a sanitizing substance, i.e., one that is suitable for killing bacteria and viruses, including from the coronavirus family.

This operation is clearly costly to carry out and has a significant impact on the management and maintenance costs of the sports facility. Moreover, in the case of outdoor playgrounds, rain and snow make the sanitization previously carried out useless or much less effective. Therefore, it may happen that intensive sanitizing procedures are necessary, further exacerbating the problem of facility management costs.

It is the object of the present invention to satisfy the need to ensure the safe performance of sports or recreational activities, while at the same time solving the problems mentioned above in reference to the sanitization systems and methods currently used.

Said object is achieved with a filament according to claim 1, with an artificial turf structure according to claim 6, and with a method for making a filament according to claim 7.

The features and advantages of the invention will become apparent from the description below of its preferred embodiments, given by way of non-limiting example, with reference to the attached figures, wherein:

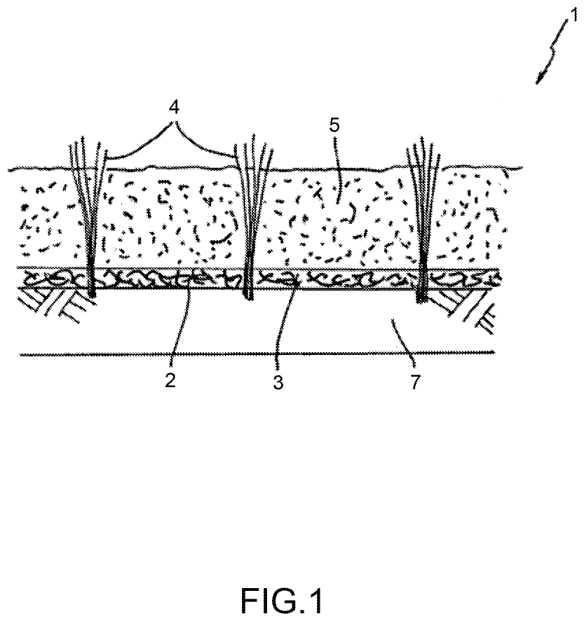

FIG. 1 is a cross-sectional view of an artificial turf surface using filaments according to the invention; and

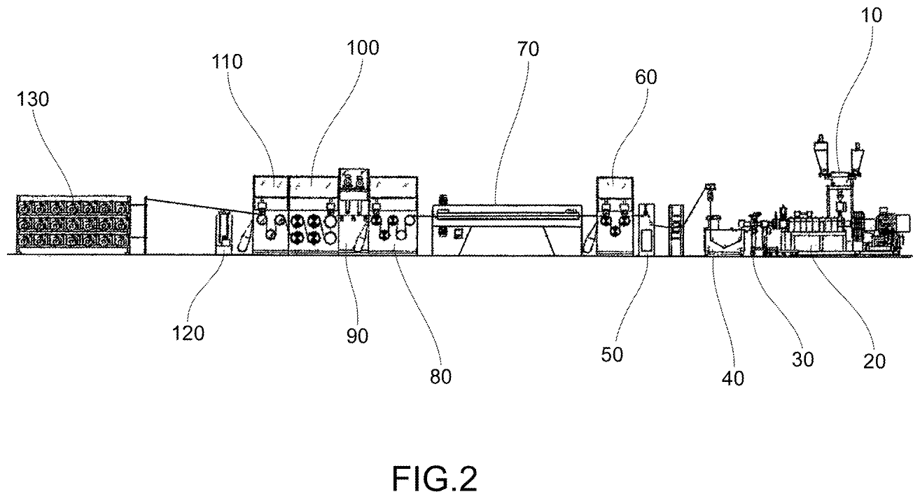

FIG. 2 is an example of a possible layout of an extrusion plant for making the filament according to the invention.

FIG. 1 shows an example of an artificial turf structure 1, particularly for sports fields, comprising a synthetic mat 2 having a substrate 3 from which filaments 4 of artificial turf protrude. An infill material 5 is arranged between the filaments 4. In use, the synthetic mat 2 is laid on a foundation 7.

Each filament 4 is made of polyethylene as a base material and, according to the invention, includes an antibacterial and antiviral additive. The chosen additive has a broad-spectrum formulation and is specifically capable of effectively and completely killing human coronavirus (Sars Cov-2) rapidly.

In particular, in a preferred embodiment, the additive is a bactericide according to ASTM 2149:2013 and a virucide according to ISO 21702:2019.

As will be described below, the additive is compatible with all types of thermoplastic resins and is suitable for the main types of processing (molding, extrusion, film, blow-molding).

For example, the additive used is “Temact Vida SL-TT” produced by the company Temakron srl. Another additive that can be used is “Sanitized MB E 19-71” produced by the company Sanitized® AG.

It has been found that a sufficient concentration of the additive is about 1-1.5% of the weight of the filament, preferably 1.2%.

Another feature that makes the additive particularly desirable is that it is slow migrating, meaning it surfaces slowly over a prolonged period of time. It has been estimated that the effect produced by the additive can last up to several years.

In a preferred embodiment, the additive is added to the polyethylene granules in the form of a granular masterbatch.

In one embodiment, the base material of the filament is LLPDE.

The filament 4 can further include other additives, such as dyes.

A possible method for making a filament according to the invention will now be described.

In a general embodiment, the method provides for mixing a granular masterbatch containing the antibacterial and antiviral additive to polyethylene granules, which form the filament base material, and any other additives, again in the form of a granular masterbatch.

In one embodiment, the percentage of the masterbatch containing the antibacterial and antiviral additive is between 4% and 10%, preferably about 6%, relative to the total weight of the material constituting the filament.

In one embodiment, wherein the filament is obtained by an extrusion process, the mixing step occurs prior to the extrusion process.

In more detail, with reference to FIG. 2, the method comprises the steps of:
loading the polyethylene granules, the masterbatch containing the antibacterial and antiviral additive, and any other additives, such as dyes, onto an automated weighing and dosing system 10;
unloading the polyethylene granules, the masterbatch containing the antibacterial and antiviral additive, and any other additives into an extruder-feeder hopper 20;
extruding the granular mixture so as to obtain at least one filament;
cooling the filaments;
subjecting the filaments to a drawing and stabilization process in a furnace;
winding the filaments into reels.

In one embodiment, the extrusion process is accomplished with a heated screw conveyor that transports, compresses, mixes, and melts the granular mixture, extruding it over a heated filtering channel, which filters the material before passing it to the dosing pump.

The dosing pump feeds the extrusion head 30 which produces monofilaments by means of a shaped die.

After the monofilaments exit the extrusion head 30, the filaments are passed through a water tank 40 for cooling. After emerging from the water, the filaments are at room temperature, dried, for example, by forced air, and then subjected to a possible cutting by a cutting assembly 50 and to a drawing and stabilization phase in a furnace 70, to which they are, for example, fed by means of a first calender 60 (slow-drawing calender).

In some embodiments, the filaments emerging from the furnace 70 can be passed through a second calender 80 (quick-drawing calender), a fibrillator assembly 90, a third stabilization calender 100, a fourth exit calender 110, and an enzymatic assembly 120.

At the end of the run, the filaments are collected by a winding unit 130. The filaments are wound onto a cardboard core by the automatic winder.

The filament incorporating antibacterial and antiviral additive allows the intended object to be achieved.

In effect, said filament breaks down viruses and bacteria, making any traditional sanitizing procedure unnecessary. The slow migration of the additive means that irrigation with a sanitizer can be avoided for several years.

Maintenance costs associated with sanitizing the surface are therefore lowered.

Note that the additive, when it migrates to the surface, sanitizes not only the filaments, but also the infill material.

The additive is introduced into the filament easily, quickly, and economically. In effect, it is supplied encapsulated in a carrier (granular masterbatch) that is mixed with the polyethylene granules of the filament, before or during the extrusion process.

Therefore, no modification of the filament manufacturing plant is required.

To the embodiments of the filament and the manufacturing method thereof according to the invention, a person skilled in the art may, in order to meet contingent needs, make changes, adaptations, and replacements of elements with functionally equivalent ones, without departing from the scope of the following claims. Each of the features described as belonging to a possible embodiment may be obtained independently of the other described embodiments.

What is claimed is:

1. A polyethylene filament for artificial turf surfaces, wherein the polyethylene filament includes an antibacterial and antiviral additive.

2. The polyethylene filament of claim 1, wherein a concentration of the antibacterial and antiviral additive is about 1-1.5% of a weight of the polyethylene filament.

3. The polyethylene filament of claim 1, wherein the antibacterial and antiviral additive is of slow-migration type.

4. The polyethylene filament of claim 1, wherein the antibacterial and antiviral additive is added to polyethylene granules in the form of granular masterbatches.

5. The polyethylene filament of claim 1, wherein a base material of the polyethylene filament is linear low density polyethylene (LLDPE).

6. An artificial turf structure, comprising a synthetic mat, having a substrate, wherein polyethylene filaments according to claim 1 protrude from the substrate, and wherein an infill material is arranged between the polyethylene filaments.

7. A method for obtaining a polyethylene filament for artificial turf surfaces, wherein the polyethylene filament includes an antibacterial and antiviral additive, the method comprising mixing a granular masterbatch containing the antibacterial and antiviral additive with polyethylene granules.

8. The method of claim 7, wherein a percentage of the granular masterbatch containing the antibacterial and antiviral additive is between 4% and 10% by weight with respect to the total weight of the polyethylene filament.

9. The method of claim 7, wherein the polyethylene filament is obtained through an extrusion process, and wherein the mixing step occurs before the extrusion process.

10. The method of claim 9, comprising:
loading the polyethylene granules, the granular masterbatch containing the antibacterial and antiviral additive and any other additives onto an automated weighing and dosing system;
unloading the polyethylene granules, the granular masterbatch containing the antibacterial and antiviral additive and any other additives into an extruder-feeding hopper;
extruding a granular mixture to obtain at least one filament;
cooling the at least one filament;
subjecting the at least one filament to a drawing and stabilization process in a furnace; and
winding the at least one filament into reels.

11. The polyethylene filament of claim 1, wherein the artificial turf surfaces are for sports fields.

12. The artificial turf structure of claim 6, wherein the artificial turf structure is for sports fields.

13. The method of claim 7, wherein a percentage of the granular masterbatch containing the antibacterial and antiviral additive is 6% by weight with respect to the total weight of the polyethylene filament.

14. The method of claim 10, wherein the other additives are dyes.
